(19) United States
(12) Patent Application Publication
(10) Pub. No.: US 2018/0113608 A1
(43) Pub. Date: Apr. 26, 2018

(54) Lighting Control Console Having A Rotary Control

(71) Applicant: MA Lighting Technology GmbH, Waldbuttelbrunn (DE)

(72) Inventors: Michael Adenau, Wurzburg (DE); Hartmut Cordes, Bremen (DE)

(21) Appl. No.: 15/356,602

(22) Filed: Nov. 20, 2016

(30) Foreign Application Priority Data
Oct. 21, 2016 (DE) 20 2016 105 915.1

(51) Int. Cl. G06F 3/0488; H05B 37/02; G06F 3/0362; G06F 3/041; G06F 3/0481

(52) U.S. Cl. CPC G06F 3/04886; H05B 37/0227; G06F 2203/04104; G06F 3/0416; G06F 3/04817; G06F 3/0362

(57) ABSTRACT

A lighting control console for controlling a lighting system, digital adjusting commands being generated in the lighting control console, which can be transmitted to the lighting devices of the lighting system via data links, includes at least one digital processor and at least one digital memory for generating, managing and storing the adjusting commands. The digital processor and the digital memory are arranged in a console housing. At least one rotary control at which the user can enter operating commands by turning a rotary button is attached to the housing. Touch sensors are provided on the rotary control and detect the number of the user's fingers in contact with the rotary button. The operating commands entered at the rotary control are determined as a function of the number of fingers in contact with the rotary button.

### CROSS-REFERENCE TO RELATED APPLICATIONS

This application claims the benefit of German Utility Model Application No. 20 2016 105 915.1 filed Oct. 21, 2016. The contents of which is hereby incorporated by reference as if set forth in its entirely herein.

### STATEMENT REGARDING FEDERALLY SPONSORED RESEARCH OR DEVELOPMENT

Not applicable.

### FIELD OF THE INVENTION

The invention relates to a lighting control console having a console housing and a rotary control attached thereto.

### BACKGROUND OF THE INVENTION

Generic lighting control consoles serve to control lighting systems such as those employed on concert stages or in theaters, for instance. Routinely, said lighting systems comprise a plurality of lighting devices, such as stage lights, the lighting devices being capable of being switched, in combination or separately, between a plurality of lighting states, such as between different colors. Said different lighting states of the lighting devices, each connected to the lighting control console, can be controlled through programmed parameters in the lighting program of the lighting control console. Standard lighting systems may comprise several thousand lighting devices. In order to be able to control such complex lighting systems, the generic lighting control consoles are equipped with a digital processor, which permits digital data and signal processing. For storing the control data, a digital memory is routinely provided, which in particular allows for storing or archiving of lighting programs. For protection of the electrical and electronic components of the lighting control console, the corresponding components are installed in a console housing, which shields the electrical and electronic components of the lighting control console from the outside.

To program the lighting program or to control the lighting program while the program is running, the operator has to enter operating commands as input values. This may entail selecting a specific lighting device or setting a specific parameter, for example. For entering these operating commands, known lighting control consoles have mechanical control elements, such as keys, rotary controls (encoders) or slide controls, which are arranged on the upper surface of the console housing in a control panel. The operating commands associated with the individual control elements can be altered by suitable menu switchovers so as to be able to program and control correspondingly complex lighting programs.

The rotary controls or encoders are of great significance when programming the lighting programs. The rotary controls comprise a rotatable operating button, which is arranged on the upper surface of the lighting control console in the control panel and can be pivoted or turned about an axis of rotation by the user in order to set specific programming parameters.

When entering operating commands at the rotary control, it is often necessary to first perform rough tuning and then fine tuning. In some cases, it is additionally necessary to be able to perform ultra fine tuning. In order to be able to solve these programming tasks by means of a rotary control, the operator of known lighting control consoles has to switch between different input modes for rough tuning, fine tuning and ultrafine tuning, which is contrary to an intuitive control of the lighting control console during programming.

### SUMMARY OF THE INVENTION

Hence, the object of the invention is to propose a new lighting control console that has a rotary control and improves intuitive operability of the lighting control console. This object is attained by a lighting control console incorporating the invention disclosed herein.

The lighting control console according to the invention is based on the idea that the rotary control is equipped with touch sensors, by means of which the number of the user's lingers in contact with the rotary button can be detected. By assessing the number of fingers in contact with the rotary button, it is possible for the operating commands entered at the rotary control to be altered by the corresponding controller of the lighting control console as a function of the number of fingers in contact with the rotary button. In particular, switching between rough tuning, fine tuning and ultrafine tuning is possible as a function of the number of fingers in contact with the rotary button of the rotary control. During control or programming of the lighting control console, the user thus has the option of switching between rough tuning, fine tuning and ultrafine tuning by changing the position of his/her fingers in relation to the rotary button. For example, when the user puts the index finger, the middle finger and the ring finger on the rotary button, this can be interpreted by the controller of the lighting control console to mean that the user would like to quickly adjust the corresponding parameter by way of rough tuning. When the user then removes the ring finger from the rotary button and makes the adjustment with the index finger and the middle finger only, this can be interpreted by the controller as fine tuning. When at last only the index finger remains on the rotary button, this can be interpreted by the controller as ultrafine tuning. In this way, actual switching by the user between the different tuning modes (rough tuning, fine tuning, ultrafine tuning) is no longer necessary and is replaced by the number of the user's fingers placed on the rotary button.

In principle, the design of the rotary control of the lighting control console is optional. It may be a mechanical encoder whose rotary button is mounted on an axis and protrudes beyond the upper surface of the console housing. Alternatively, it is especially cost-effective to realize the lighting control console having the rotary control according to the invention in such a manner that the rotary button of the rotary control is displayed as an icon on a touch screen. In this way, the touch sensors by which the number of fingers in contact with the rotary button is detected can be realized in a simple manner by the motion sensors of the touch screen.

If the rotary control is realized by displaying corresponding image signals on a touch screen, it is particularly advantageous if the rotary button of the rotary control displayed on the touch screen is not activated for entries by the controller before at least one fingertip has been detected, as being in contact with the rotary button. In this way, erroneous entries by unintentional touching of the rotary button displayed on the touch screen can be avoided. It is contemplated, for example, that the user first has to touch the center of the displayed rotary button with the fingertip of the thumb, for example, in order to activate the input of data. Only after the tip of the thumb is in contact with the center of the rotary button, the rotary button can be adjusted by corresponding adjusting motions of the index finger and/or of the middle finger and/or of the ring finger and/or of the little finger.

In principle, the manner in which operating commands entered at the rotary control are altered as a function of the number of fingers in contact with the rotary button is optional. It may happen in a particularly simple manner by the controller multiplying the operating commands entered at the rotary control by a multiplication factor derived from the number of fingers in contact with the rotary button. In this way, rough tuning, fine tuning and/or ultrafine tuning can be realized depending on the indicated multiplication factor.

For the user to be able to optimize the type of modification of the entries as a function of the number of fingers in contact with the rotary button, it is particularly advantageous if the multiplication factor can be set in the controller. In this way, the user has the option of adjusting the differences between rough tuning, fine tuning and ultrafine tuning to his/her individual needs.

In case of ultrafine tuning, the multiplication factor can preferably correspond to one time the number of fingers in contact with the rotary button. To realize fine tuning, the multiplication factor can correspond to ten times the number of fingers in contact with the rotary button.

To realize rough tuning, the multiplication factor can correspond to one hundred times the number of fingers in contact with the rotary button.

If one finger tip, such as the tip of the thumb, being in contact with the rotary button is interpreted by the controller as an activating signal for activating entries at the rotary button, the multiplications factors for rough tuning, fine tuning and ultrafine tuning are to be reduced by the corresponding number of fingers in contact with the rotary button multiplied by the corresponding multiplication factor. This means that for ultra fine tuning, the multiplication factor corresponds to one time the number of fingers in contact with the rotary button minus one.

For fine tuning, the multiplication factor corresponds to ten times the number of fingers in contact with the rotary button minus ten.

For rough tuning, the multiplication factor corresponds to one hundred times the number of fingers in contact with the rotary button minus one hundred.

An embodiment of the invention is schematically illustrated in the drawing and will be explained hereinafter by way of example.

### BRIEF DESCRIPTION OF THE DRAWINGS

In the drawing:

FIG. 1 shows a top view of a lighting control console for controlling a lighting system, the lighting control console having several rotary controls:

FIG. 2 shows a touch screen of the lighting control console of FIG. 1 including the rotary button of a rotary control displayed thereon as an icon;

FIG. 3 shows the touch screen of FIG. 2 in a schematized section view along section line I-I during rough tuning of the rotary control;

FIG. 4 shows the touch screen of FIG. 3 during fine tuning; and

FIG. 5 shows the touch screen of FIG. 4 during ultrafine tuning.

### DETAILED DESCRIPTION OF THE EXAMPLE EMBODIMENTS

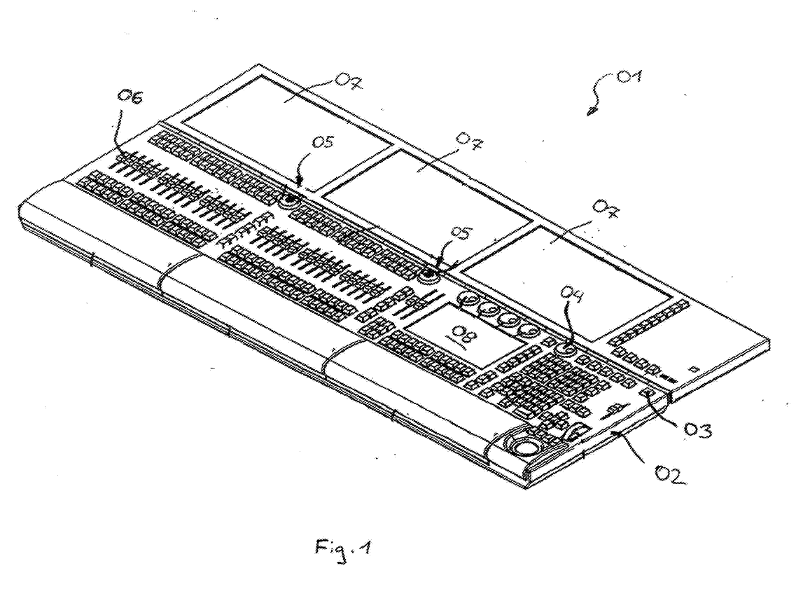

FIG. 1 shows a top view of a lighting control console 01 for controlling a lighting system not illustrated in other respects. For entering operating commands of the user during programming of lighting programs, a plurality of mechanical control elements such as keys 03, rotary controls 04, dual encoders 05 and slide controls 06 are installed in the console housing 02. Additionally, the lighting control console 01 comprises two touch screens 07 and 08, on whose screens image content can be displayed and which are equipped with touch sensors so as to be able to detect the touch of the user's fingers.

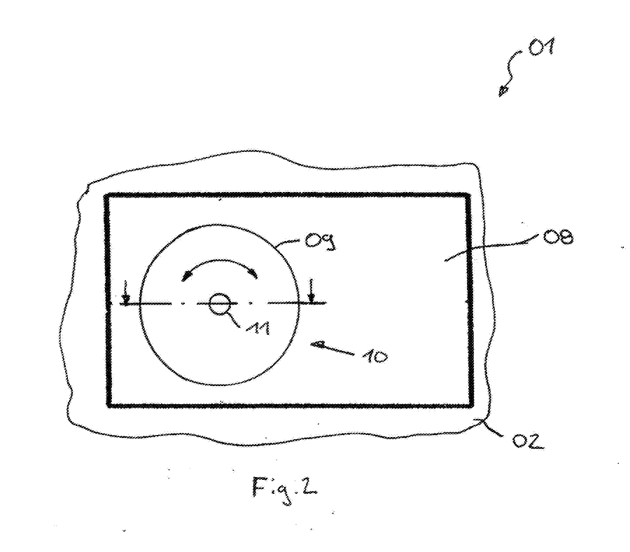

FIG. 2 shows an enlarged section of the touch screen 08 of the lighting control console 01. In the operating state illustrated in FIG. 2, the rotary button 09 of a rotary control 14 which is symbolically illustrated on the touch screen 08, is displayed on the touch screen 08. The rotary button 09 can be moved rotatorily by the user through corresponding swiping motions on the screen surface of the touch screen 08 so as to enter adjusting commands on the lighting control console 01. In the center of the rotary button 09, there is an activating switch 11. Once the user is touching the rotary button 09 with a fingertip, such as the tip of the thumb, in the area of the activating button 11, entry commands can be entered by turning the rotary button 09 by means of corresponding swiping motions of the tips of the other fingers of the user's hand.

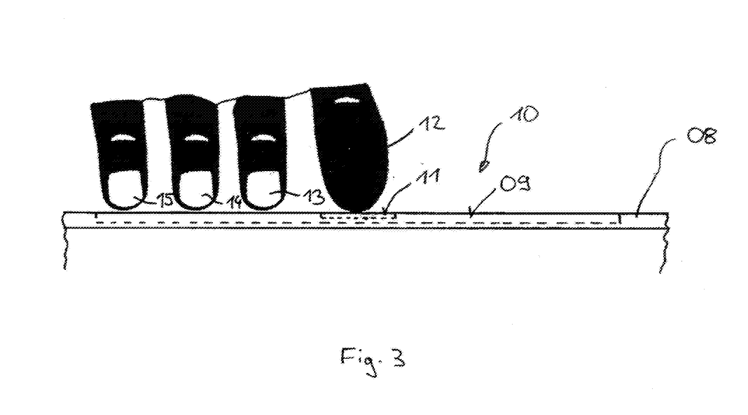

FIG. 3 shows a schematized lateral view of the touch screen 08 during entry of a rough tuning for a specific lighting parameter. The rotary button 09 and the activating switch 11 are only indicated symbolically since these control elements are displayed as image content on the touch screen 08. As soon as the user's thumb is touching the activating button 11, operating commands can be entered at the rotary button 09. If the user now touches the rotary button 09 with three finger tips simultaneously, namely the tip of the index finger 13, the tip of the middle finger 14 and the tip of the ring finger 15, this touching of the touch screen with the three other fingers tips in addition to the tip of the thumb is interpreted to mean that the user would like to perform rough tuning. Hence, the turning motions of the rotary button 09 entered by swiping motions of the three finger tips 13, 14 and 15 are multiplied by the factor 30 (three fingers times the factor 10 for rough tuning).

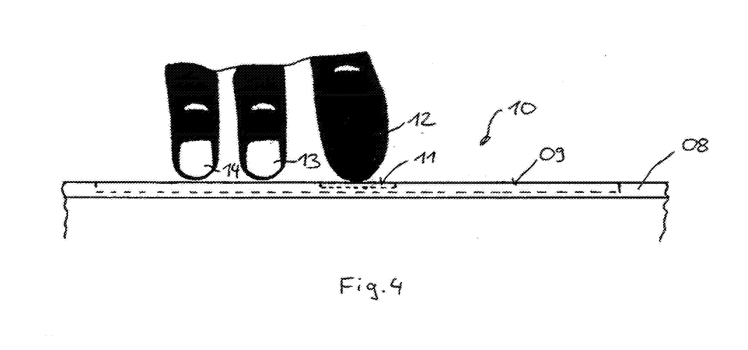

FIG. 4 shows the touch screen 08 during fine tuning. In contrast to the illustration of FIG. 3, the user continues touching the rotary button 09 with the tip of the thumb 12 in the area of the activating button 11. The rotary button 09 itself is touched by the user with the tip of the index finger 13 and the tip of the middle finger 14 only. This touch at two touching points outside of the activating button 11 is interpreted by the controller to the effect that the swiping motions of the finger tips 13 and 14 and the resulting rotation of the rotary button 09 are multiplied by the factor 20.

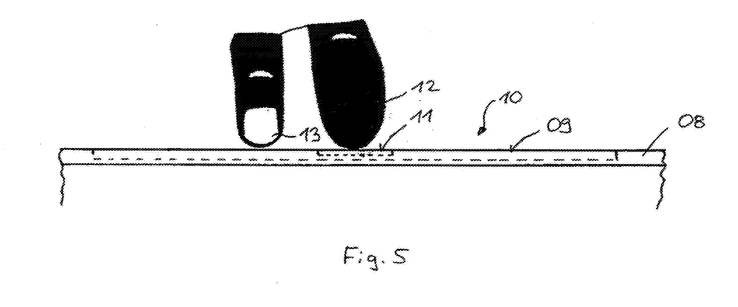

FIG. 5 shows the touch screen 08 during ultrafine tuning of a lighting parameter. For ultrafine tuning, the user activates the rotary button 09 by touching the activating button 11 with the tip of the thumb 12 and now swipes only the tip of the index finger 13 across the touch surface of the rotary button 09. The corresponding adjusting motions of the rotary button 09 are now multiplied by just the factor 10.

1. A lighting control console for controlling a lighting system, the lighting control console comprising:
a console housing;
at least one rotary control attached to said console housing, wherein a user can enter operating commands by turning a rotary button of said at least one rotary control; and
touch sensors detecting a number of the user's fingers in contact with the rotary button, the operating commands entered at the rotary control being determined as a function of the number of fingers detected by the touch sensors in contact with the rotary button.

2. The lighting control console according to claim 1, in which the rotary button is displayed as an icon on a touch screen, the touch sensors being formed by sensors of the touch screen.

3. The lighting control console according to claim 2, in which the rotary button of the rotary control displayed on the touch screen is activated for entries by a controller when a finger is in contact with the rotary button.

4. The lighting control console according to claim 3, in which the rotary button of the rotary control displayed on the touch screen is activated for entries by a controller when a finger is in contact with an area proximal a displayed activating button.

5. The lighting control console according to claim 1, in which the operating commands entered at the rotary control are multiplied by the controller by a multiplication factor derived from the number of fingers in contact with the rotary button detected by the touch sensors.

6. The lighting control console according to claim 5, in which the multiplication factor can be set in the controller.

7. The lighting control console according to claim 5, in which the multiplication factor is one time the number of fingers in contact with the rotary button detected by the touch sensors.

8. The lighting control console according to claim 5, in which the multiplication factor is ten times the number of fingers in contact with the rotary button detected by the touch sensors.

9. The lighting control console according to claim 5, in which the multiplication factor is one hundred times the number of fingers in contact with the rotary button detected by the touch sensors.

10. The lighting control console according to claim 5, in which the multiplication factor is one time the number of fingers in contact with the rotary button detected by the touch sensors minus one.

11. The lighting control console according to claim 5, in which the multiplication factor is ten times the number of fingers in contact with the rotary button detected by the touch sensors minus ten.

12. The lighting control console according to claim 5, in which the multiplication factor is one hundred times the number of fingers in contact with the rotary button minus one hundred.

13. The lighting control console according to claim 1, including at least one digital processor and at least one digital memory for generating, managing and storing the adjusting commands, the digital processor and the digital memory being arranged in the console housing

14. A lighting control console for controlling a lighting system, the lighting control console comprising:
a touch screen;
at least one rotary control displayed as an icon on said touch screen, wherein a user can enter operating commands by turning a rotary button of said at least one rotary control; and
touch sensors detecting a number of the user's fingers in contact with the rotary button, the operating commands entered at the rotary control being determined as a function of the number of fingers detected by the touch sensors in contact with the rotary button.

15. The lighting control console according to claim 14, in which said touch screen is mounted on a console housing.

16. The lighting control console according to claim 14, in which at least one digital processor and at least one digital memory for generating, managing and storing the adjusting commands is arranged in the console housing.

17. The lighting control console according to claim 14, in which said touch sensors are formed by sensors of the touch screen.

18. A method of operating a lighting control console controlling a lighting system, digital adjusting commands being generated in the lighting control console, which can be transmitted to lighting devices of the lighting system via data links, the method comprising:
entering an operating command into the lighting control console by rotating a rotary button of at least one rotary control using user fingers; and
detecting a number of user fingers in contact with the rotary button, said number of fingers in contact with the rotary button being detected by sensors, and the operating commands entered at the rotary control using the user fingers being determined as a function of the number of fingers detected by the sensors in contact with the rotary button.

19. The method according to claim 18, in which the rotary button is displayed as an icon on a touch screen, and the number of fingers in contact with the rotary button are detected by touch sensors being formed by sensors of the touch screen.
